(19) United States
(12) Patent Application Publication
(10) Pub. No.: US 2021/0317348 A1
(43) Pub. Date: Oct. 14, 2021

(54) Adhesive Composition and Thermally Fusible Member Using the Same

(71) Applicant: TOAGOSEI CO., LTD., Minato-ku, Tokyo (JP)

(72) Inventors: Takahiro ITOU, Nagoya-shi, Aichi (JP); Makoto HIRAKAWA, Nagoya-shi, Aichi (JP)

(21) Appl. No.: 17/272,502

(22) PCT Filed: Sep. 3, 2019
(86) PCT No.: PCT/JP2019/034645

§ 371 Date: Mar. 1, 2021

(30) Foreign Application Priority Data
Sep. 4, 2018 (JP) 2018-164976

(51) Int. Cl. C09J 123/26; C09J 11/06; B32B 15/08; B32B 7/12; H01M 50/124; H01M 10/0525

(52) U.S. Cl. CPC C09J 123/26; C09J 11/06; B32B 15/08; B32B 2457/10; H01M 50/124; H01M 10/0525; C09J 2301/408; B32B 7/12

(57) ABSTRACT

An adhesive composition, comprising: an organic solvent; (A) a polyolefin that has an acidic group and/or an acid anhydride group and that is soluble in the organic solvent; and an isocyanate compound, wherein the isocyanate compound is (B) an isocyanate compound having an alicyclic structure, and/or a derivative thereof.

### TECHNICAL FIELD

The present invention relates to an adhesive composition and a thermally fusible member using the same, can be used in various fields of industrial products such as electrical fields, automotive fields, and industrial fields, and belongs to these technical fields.

### BACKGROUND ART

A hot-melt type adhesive composition is processed into a film shape or a sheet shape and then is used, and has been utilized in various fields of industrial products such as electrical fields, automotive fields and industrial fields, as an adhesive film or sheet which has an adhesive composition laminated onto a surface of the member.

Various adhesive compositions have been proposed in order to bond a metal member such as iron, aluminum, titanium, another metal, an alloy thereof or the like, which are used in the above-mentioned fields, to a molded body made from polyolefin which has poor adhesiveness.

Japanese Patent Application Laid-Open (JP-A) No. H4-18480 discloses an adhesive composition obtained by dissolving and dispersing, in an organic solvent, a component consisting of a carboxylic acid-containing polyolefin, a carboxylic acid-containing epoxy resin, a polyisocyanate compound and, if necessary, an epoxy resin.

Japanese Patent Application Laid-Open (JP-A) No. 2015-36385 discloses an adhesive composition containing a polyolefin having a carboxyl group or an acid anhydride group, a polyfunctional isocyanate compound and a solvent, in which the glass transition temperature, the melting point, and the melting energy of the polyolefin are specific values.

### SUMMARY OF INVENTION

### Technical Problem

However, the adhesive compositions described in JP-A No. H4-18480 and JP-A No. 2015-36385 have adhesiveness at room temperature (25° C.) (hereinafter referred to as “room-temperature peel strength”) of 5 N/15 mm or higher, which is in the range of practical use with there still being room for improvement, and the adhesiveness at a high temperature of about 80° C. (hereinafter referred to as “high-temperature peel strength”) is insufficient.

Further, in a case in which packaging materials for lithium-ion batteries are produced using these adhesive compositions, although the packaging materials do not come in contact with the electrolytic solution during normal use, the packaging materials need to have adhesiveness after having been immersed in an electrolytic solution at a high temperature of about 80° C. (hereinafter referred to as “electrolyte resistance”) in case of abnormalities. However, there is a problem that they are insufficient in the electrolyte resistance.

An object of one embodiment of the present invention is to provide an adhesive composition having excellent adhesion of a room-temperature peel strength of 20 N/15 mm or higher and a high-temperature peel strength of 10 N/15 mm or higher and also having excellent electrolyte resistance even in a case of being used for packaging materials for lithium-ion batteries, and a thermally fusible member using the adhesive composition.

### Solution to Problem

As a result of an extensive investigation in order to solve the above problems, the present inventors have found that an adhesive composition containing an organic solvent, a polyolefin that has an acidic group and/or an acid anhydride group and that is soluble in the organic solvent, and a specific type of isocyanate compound, has a high room-temperature peel strength and a high high-temperature peel strength and thus is excellent in adhesiveness, and is also excellent in electrolyte resistance even in a case of being used for packaging materials for lithium-ion batteries, and have completed the present invention.

The present invention includes the following embodiments.

[1] An adhesive composition, comprising: an organic solvent; (A) a polyolefin that has an acidic group and/or an acid anhydride group and that is soluble in the organic solvent; and an isocyanate compound, wherein the isocyanate compound is (B) an isocyanate compound having an alicyclic structure, and/or a derivative thereof.

[2] The adhesive composition according to [1], wherein the isocyanate compound having an alicyclic structure is at least one selected from the group consisting of hydrogenated xylylene diisocyanate, a derivative of hydrogenated xylylene diisocyanate, 4,4′-methylenebis(cyclohexyl isocyanate), an isomer of 4,4′-methylenebis(cyclohexyl isocyanate), a derivative of 4,4′-methylenebis(cyclohexyl isocyanate), and a derivative of an isomer of 4,4′-methylenebis(cyclohexyl isocyanate).

[3] The adhesive composition according to [1] or [2], further comprising (C) an aliphatic isocyanate compound not having an alicyclic structure, and/or a derivative thereof.

[4] The adhesive composition according to any one of [1] to [3], wherein the aliphatic isocyanate compound not having an alicyclic structure is a compound having a linear alkyl group with 4 to 18 carbon atoms.

[5] The adhesive composition according to any one of [1] to [4], wherein the derivative of the isocyanate compound having an alicyclic structure and/or the derivative of the aliphatic isocyanate compound not having an alicyclic structure is a compound including at least one bond selected from the group consisting of an isocyanurate bond, a burette bond, a urethane bond, and an allophanate bond.

[6] The adhesive composition according to any one of [1] to [5], wherein the component (A) is a polyolefin that is graft-modified with an acidic group-containing monomer and/or an acid anhydride group-containing monomer, and a graft amount thereof is from 0.10 to 30% by mass.

[7] The adhesive composition according to any one of [1] to [6], wherein the component (A) is a polyolefin that is graft-modified with an esterified product of an alkyl alcohol having 8 to 18 carbon atoms and (meth)acrylic acid, and a graft amount thereof is from 0.10 to 20% by mass.

[8] The adhesive composition according to any one of [1] to [7], wherein a weight-average molecular weight of the component (A) is from 15,000 to 200,000, and a melting point of the component (A) is from 50 to 100° C.

[9] A thermally fusible member, comprising: an adhesive layer that is formed by curing the adhesive composition according to any one of [1] to [8]; a metal layer that is bonded to one side of the adhesive layer; and a thermally fusible resin layer that is bonded to another side of the adhesive layer.

[10] A packaging material for a lithium-ion battery, comprising the thermally fusible member according to [9].

### Advantageous Effects of Invention

According to the present disclosure, an adhesive composition and a thermally fusible member using the same, which have high room-temperature peel strength and high high-temperature peel strength and thus are excellent adhesiveness, and which are also excellent in electrolyte resistance even in a case of being used for packaging materials for lithium-ion batteries, can be obtained.

### BRIEF DESCRIPTION OF DRAWINGS

FIG. 1 is a schematic perspective view showing an example of a thermally fusible member of the present disclosure.

FIG. 2 is a schematic perspective view showing another example of the thermally fusible member of the present disclosure.

### DESCRIPTION OF EMBODIMENTS

A first aspect of the present invention (an adhesive composition of the present disclosure) relates to an adhesive composition that contains an organic solvent, (A) a polyolefin that has an acidic group and/or an acid anhydride group and that is soluble in the organic solvent, and an isocyanate compound, in which the isocyanate compound is (B) an isocyanate compound having an alicyclic structure, and/or a derivative thereof.

Hereinafter, component (A), component (B), component (C), an organic solvent, other components, an adhesive composition, a method of producing an adhesive composition, a thermally fusible member, a method of producing a thermally fusible member and its applications will be described.

In the present specification, acrylic acid and/or methacrylic acid is referred to as (meth)acrylic acid.

1. Component (A).

The component (A) is a polyolefin having an acidic group and/or an acid anhydride group.

As the component (A), a polyolefin that is modified with an acidic group-containing monomer and/or an acid anhydride group-containing monomer is preferable from the viewpoint that the room-temperature peel strength and the high-temperature peel strength are high.

As the component (A), a polyolefin that is modified with an acidic group-containing monomer and/or an acid anhydride group-containing monomer, and a (meth)acrylic acid ester are preferable from the viewpoint that solubility in organic solvents and compatibility with other resins are excellent.

Specific examples of the polyolefin constituent unit of the component (A) include constituent units derived from ethylene, propylene, and α-olefins such as 1-butene, isobutylene, 1-hexene and 1-octene. Among these, constituent units derived from ethylene, propylene and 1-butene are preferable from the viewpoint that the high-temperature peel strength and the electrolyte resistance can be improved in a case in which a non-polar polyolefin resin with poor adhesiveness such as crystalline polyethylene or polypropylene is used as an adherend.

Specific examples of the acidic group include a carboxylic acid group, a sulfonic acid group and a phosphoric acid group, and among these, a carboxylic acid group is preferable from the viewpoint that the modification is easy.

Specific examples of the acid anhydride group include a carboxylic acid anhydride group, a sulfonic acid anhydride group and a phosphoric acid anhydride group, and among these, a carboxylic acid anhydride group is preferable from the viewpoint that the raw materials are easily available and that the modification is easy.

As a modification method, a known method can be employed. Examples thereof include graft modification which allows an acidic group-containing monomer and/or an acid anhydride group-containing monomer to addition-react with a polyolefin and copolymerization of an acidic group-containing monomer and/or an acid anhydride group-containing monomer with olefins and or the like, in the presence of a known radical polymerization initiator such as an organic peroxide or an aliphatic azo compound in a state of being melt-kneaded or in an organic solvent.

The component (A) may be further graft-modified with a (meth)acrylic acid alkyl ester, an esterified product of an alkyl alcohol having 8 to 18 carbon atoms and a (meth)acrylic acid (hereinafter referred to as “(meth)acrylic acid long chain alkyl ester”) being preferable as the (meth)acrylic acid alkyl ester.

In the case of improving the graft amount of the acidic group-containing monomer, the graft amount of the acid anhydride group-containing monomer, and the graft amount of the (meth)acrylic acid long chain alkyl ester in the component (A), examples of the unmodified polyolefin, which is a raw material, include polyethylene, polypropylene, a random copolymer of propylene and ethylene, a block copolymer of propylene and ethylene, a random copolymer of ethylene and an α-olefin, a block copolymer of ethylene and an α-olefin, a random copolymer of propylene and an α-olefin, and a block copolymer of propylene and an α-olefin.

Among these, polypropylene-based polymers such as a propylene-ethylene copolymer, a propylene-1-butene copolymer, and a propylene-ethylene-1-butene copolymer are preferable from the viewpoint that the high-temperature peel strength and electrolyte resistance can be improved in a case in which non-polar polyolefin resin with poor adhesiveness such as crystalline polyethylene or polypropylene is used as an adherend. Further, it is more preferable that the propylene unit is 50% by mass or more of the polyolefin.

In order to improve the graft amount of the acidic group-containing monomer, the graft amount of the acid anhydride group-containing monomer, and the graft amount of the (meth)acrylic acid long chain alkyl ester in the component (A), it is preferable to use an organic peroxide such as benzoyl peroxide, dicumyl peroxide, lauroyl peroxide, di-t-butyl peroxide, 2,5-dimethyl-2,5-di(t-butylperoxy)hexane and cumene hydroperoxide, and it is possible to use a reaction aid and a stabilizer for adjusting resin stability.

Specific examples of the reaction aid include styrene, o-methylstyrene, p-methylstyrene, α-methylstyrene, divinylbenzene, hexadiene and dicyclopentadiene.

Specific examples of the stabilizer include hydroquinone, benzoquinone and nitrosophenyl hydroxy compounds.

1-1. Acidic Group-Containing Monomer

Examples of the acidic group-containing monomer used as a raw material of the component (A) include compounds having an ethylenic double bond and a carboxylic acid group or the like in the same molecule, and specifically, various unsaturated monocarboxylic acid compounds, unsaturated dicarboxylic acid compounds, and unsaturated tricarboxylic acid compounds.

Specific examples of the unsaturated monocarboxylic acid compounds include acrylic acid, methacrylic acid, crotonic acid and isocrotonic acid.

Specific examples of the unsaturated dicarboxylic acid compounds include maleic acid, itaconic acid, citraconic acid, tetrahydrophthalic acid, nadic acid and endic acid.

Examples of the unsaturated tricarboxylic acid compounds include aconitic acid.

As the acidic group-containing monomer, from the viewpoint that modification is easy and adhesiveness is excellent, the unsaturated dicarboxylic acid compound and the unsaturated tricarboxylic acid compound are preferable, and itaconic acid, maleic acid, and aconitic acid are more preferable.

These acidic group-containing monomers may be used alone, or two or more thereof may be used in combination.

In a case in which a part of the acidic group-containing monomer used for the modification is unreacted, it is preferable to use, as the component (A), a component from which the unreacted acidic group-containing monomer has been removed by a known method such as heat distillation or reprecipitation purification in order to suppress an adverse effect on the adhesive strength.

In a case in which the component (A) is a polyolefin that is graft-modified with an acidic group-containing monomer, it is preferable that the graft amount of the acidic group-containing monomer in the component (A) is from 0.10 to 30% by mass with respect to the total mass of the component (A). From the viewpoint of being able to maintain solubility in a solvent and adhesiveness to a material such as a metal adherend, the graft amount is preferably 0.10% by mass or more, and more preferably 0.50% by mass or more. Further, from the viewpoint of obtaining sufficient adhesiveness, the graft amount is preferably 30% by mass or less, more preferably 20% by mass or less, and even more preferably 10% by mass or less.

The graft amount of the acidic group-containing monomer can be measured by a known method. For example, the graft amount can be determined by alkalimetry or Fourier transform infrared spectroscopy.

1-2. Acid Anhydride Group-Containing Monomer

Examples of the acid anhydride group-containing monomer used as a raw material of the component (A) include compounds having an ethylenic double bond and a carboxylic acid anhydride group or the like in the same molecule. Specifically, examples thereof include acid anhydrides of the aforementioned unsaturated monocarboxylic acid compounds, acid anhydrides of the aforementioned unsaturated dicarboxylic acid compounds, and acid anhydrides of the aforementioned unsaturated tricarboxylic acid compounds.

Specific examples of the acid anhydrides of the unsaturated monocarboxylic acid compound include acrylic acid anhydride, methacrylic acid anhydride, crotonic acid anhydride and isocrotonic acid anhydride.

Specific examples of the acid anhydrides of the unsaturated dicarboxylic acid compound include maleic acid anhydride, itaconic acid anhydride, citraconic acid anhydride, tetrahydrophthalic acid anhydride, nadic acid anhydride and endic acid anhydride and the like.

Specific examples of the acid anhydrides of the unsaturated tricarboxylic acid compound include aconitic acid anhydride.

As the acid anhydride group-containing monomer, the acid anhydrides of the unsaturated dicarboxylic acid compound and the acid anhydrides of the unsaturated tricarboxylic acid compound are preferable, and itaconic acid anhydride, maleic acid anhydride, and aconitic acid anhydride are more preferable, from the viewpoint that modification is easy and adhesiveness is excellent.

These acid anhydride group-containing monomers may be used alone, or two or more thereof may be used in combination.

In a case in which a part of the acid anhydride group-containing monomer used for the modification is unreacted, it is preferable to use, as the component (A), a component from which the unreacted acid anhydride group-containing monomer has been removed by a known method such as heat distillation or reprecipitation purification in order to suppress an adverse effect on the adhesive strength.

In a case in which the component (A) is a polyolefin that is graft-modified with an acid anhydride group-containing monomer, it is preferable that the graft amount of the acid anhydride group-containing monomer in the component (A) is from 0.10 to 30% by mass with respect to the total amount of the component (A). From the viewpoint of being able to maintain solubility in a solvent and adhesiveness to a material such as a metal adherend, the graft amount is preferably 0.10% by mass or more, and more preferably 0.50% by mass or more. Further, from the viewpoint of obtaining sufficient adhesiveness, the graft amount is preferably 30% by mass or less, more preferably 20% by mass or less, and even more preferably 10% by mass or less.

The graft amount of the acid anhydride group-containing monomer can be measured by a known method. For example, the graft amount can be determined by alkalimetry or Fourier transform infrared spectroscopy.

1-3. (Meth)Acrylic Acid Long Chain Alkyl Ester

Specific examples of the (meth)acrylic acid long chain alkyl ester used as a raw material of the component (A) include octyl (meth)acrylate, lauryl (meth)acrylate, tridecyl (meth)acrylate and stearyl (meth)acrylate, and octyl (meth)acrylate, lauryl (meth)acrylate and tridecyl (meth)acrylate are preferable from the viewpoint that adhesiveness can be improved in a case in which a non-polar polyolefin resin with poor adhesiveness is used as an adherend.

It is preferable that the graft amount of the aforementioned (meth)acrylic acid long chain alkyl ester in the component (A) is from 0.10 to 20% by mass with respect to the total amount of the component (A). From the viewpoint of being able to favorably maintain solubility of the component (A) in the solvent, compatibility with other resins, and adhesiveness, the graft amount is preferably 0.10% by mass or more. Further, from the viewpoint of being able to favorably maintain adhesiveness, the graft amount is preferably 20% by mass or less, more preferably 10% by mass or less, and even more preferably 5.0% by mass or less.

The graft amount of the aforementioned (meth)acrylic acid long chain alkyl ester can be measured by a known method. For example, the graft amount can be determined by Fourier transform infrared spectroscopy or a 1H-NMR method.

According to the purpose, monomers other than the above-mentioned acidic group-containing monomer and/or the acid anhydride group-containing monomer, and the above-mentioned (meth)acrylic acid long chain alkyl ester (hereinafter referred to as “other monomers”), can be used in combination to the extent that the characteristics of the adhesive composition of the present disclosure are not impaired.

Specific examples of the other monomers include (meth)acrylic acid esters other than those described above, such as hydroxyethyl (meth)acrylate, benzyl (meth)acrylate, glycidyl (meth)acrylate and an isocyanate-containing (meth)acrylic acid, and unsaturated monomers that can copolymerize with olefins such as styrene, cyclohexyl vinyl ether and dicyclopentadiene.

The use in combination with other monomers makes it possible to further improve adhesiveness and solubility in solvents, the graft amount of the acidic group-containing monomer and/or the graft amount of the acid anhydride group-containing monomer, and the graft amount of the above-mentioned (meth)acrylic acid long chain alkyl ester. It is preferable that the usage amount of the other monomers does not exceed the total of the graft amount of the acidic group-containing monomer and/or the graft amount of the acid anhydride group-containing monomer and the graft amount of the above-mentioned (meth)acrylic acid long chain alkyl ester.

According to the purpose, the component (A) may be a polyolefin having an ethylenically unsaturated group in addition to an acidic group and/or an acid anhydride group to the extent that the characteristics of the adhesive composition of the present disclosure are not impaired.

Examples of a method of introducing an ethylenically unsaturated group into the component (A) include, for example, adding a hydroxyl group-containing ethylenically unsaturated monomer such as hydroxyl ethyl (meth)acrylate, and an epoxy group-containing ethylenically unsaturated monomer such as glycidyl (meth)acrylate, to the acidic group and/or acid anhydride group contained in the component (A).

The weight-average molecular weight of the component (A) is preferably from 15,000 to 200,000. From the viewpoint of being able to improve room-temperature peel strength and electrolyte resistance, the weight-average molecular weight is preferably 15,000 or more, more preferably 30,000 or more, and even more preferably 40,000 or more. Further, from the viewpoint of being able to improve solubility in an organic solvent in the adhesive composition, the weight-average molecular weight is preferably 200,000 or less, and more preferably 150,000 or less.

In the present disclosure, the weight-average molecular weight means a value obtained by converting a molecular weight measured by gel permeation chromatography into a polystyrene equivalent.

The melting point of the component (A) is preferably from 50 to 100° C. From the viewpoint of being able to obtain sufficient peel strength, the melting point is preferably 50° C. or higher, and more preferably 60° C. or higher. Further, from the viewpoint of being able to obtain sufficient storage stability at low temperature, the melting point is preferably 100° C. or lower, and more preferably 95° C. or lower.

The melting point of the component (A) is measured as follows.

In accordance with the provisions of JIS K 7121 (established in 1987), measurement is performed at a temperature increase rate of 10° C./min using a differential scanning calorimeter, and the temperature at the time of crystallization is defined as the melting point (hereinafter, “Tm”).

The component (A) contained in the adhesive composition of the present disclosure may be used alone, or two or more thereof may be used in combination.

The content of the component (A) is preferably from 80 to 100%, and more preferably from 90 to 100% by mass, with respect to 100% by mass of the solid content of the adhesive composition, from the viewpoint that high-temperature peel strength and electrolyte resistance are excellent.

2. Isocyanate Compound

As the isocyanate compound used in the adhesive composition of the present disclosure, (B) an isocyanate compound of a hydrocarbon having an alicyclic structure, and/or a derivative thereof, and (C) an isocyanate compound of a saturated aliphatic hydrocarbon not having an alicyclic structure, and/or a derivative thereof, are used.

Due to having good compatibility with the component (A), the component (B) has a high effect of increasing the cross-linking density of the cured product and has an effect of improving the high-temperature peel strength and reducing the swelling of the adhesive with the electrolytic solution or the like, and the component (C) has an effect of improving adhesion to the adherend.

2-1. Component (B)

The component (B) is an isocyanate compound having an alicyclic structure (hereinafter referred to as “component (b)”), and/or a derivative thereof.

Specific examples of the component (b) include hydrogenated xylylene diisocyanate (including structural isomers 1,2-bis(isocyanatomethyl)cyclohexane, 1,3-bis(isocyanatomethyl)cyclohexane and 1,4-bis(isocyanatomethyl)cyclohexane, and their stereoisomers), 4,4′-methylenebis(cyclohexyl isocyanate) and its structural isomers (2,2′-methylenebis(cyclohexyl isocyanate) and 2,4′-methylenebis(cyclohexyl isocyanate)), and their stereoisomers, norbornane dimethyl isocyanate, and isophorone diisocyanate (including isomers).

As the component (b), diisocyanate compounds having at least one alicyclic structure are preferable from the viewpoint that the effect of improving high-temperature peel strength is high, and among these, hydrogenated xylylene diisocyanate and 4,4′-methylenebis(cyclohexyl isocyanate) and its isomers are more preferred.

As a derivative of the component (b), a compound containing an isocyanurate bond, a burette bond, a urethane bond and/or an allophanate bond is preferable, and a compound containing an isocyanurate bond is more preferable.

The derivative of the component (b) may have a urea bond and/or a uretdione bond.

In the adhesive composition of the present disclosure, the component (B) is preferably dissolved in an organic solvent.

As the component (B), commercially available products may be used.

Examples of the isocyanate compound having an alicyclic structure (component (b)) include HMDI (manufactured by Wanhua Chemical Group Co., Ltd.), Desmodur W (manufactured by Sumika Covestro Urethane Co., Ltd.), Fortimo (manufactured by Mitsui Chemicals, Inc.), Takenate 600 (manufactured by Mitsui Chemicals, Inc.), Cosmonate NBDI (manufactured by Mitsui Chemicals, Inc.) and IPDI (manufactured by Beyond Industries Limited).

Examples of the derivative of component (b) include commercially available products of a compound having an isocyanurate bond, such as Desmodur Z4470BA (manufactured by Sumika Covestro Urethane Co., Ltd.) and Duranate T4900-70B (manufactured by Asahi Kasei Corporation).

Examples of commercially available products of a compound having an allophanate bond include Desmodur XP2565 (manufactured by Sumika Covestro Urethane Co., Ltd.).

Examples of commercially available products of a compound having a urethane bond include Takenate D-140N (manufactured by Mitsui Chemicals, Inc.), which is an adduct of isophorone diisocyanate with trimethylolpropane, and VESTANAT EP-DC1241 (manufactured by Evonic Japan Co., Ltd.), which is a monoadduct of isophorone diisocyanate with hydroxyethyl acrylate.

2-2. Component (C)

The component (C) is an aliphatic isocyanate compound not having an alicyclic structure (hereinafter referred to as “component (c)”), and/or a derivative thereof.

As the component (c), a component having a linear alkyl group with 4 to 18 carbon atoms is preferable from the viewpoint that the effect of improving the room-temperature peel strength of the adhesive composition is high.

Specific examples of the component (c) include hexamethylene diisocyanate, pentamethylene diisocyanate and tetramethylene diisocyanate, and hexamethylene diisocyanate is preferable as the component (c) from the viewpoint that the effect of improving the adhesion to an adherend is high.

As the derivative of the component (c), a compound containing an isocyanurate bond, a burette bond, a urethane bond and/or an allophanate bond is preferable, and a compound containing an isocyanurate bond is more preferable from the viewpoint that the effect of improving the adhesion to the adherend is high and the room-temperature peel strength and the electrolyte resistance can be improved.

The derivative of the component (c) may have a urea bond and/or a uretdione bond.

As the derivative of the component (c), commercially available products can be used.

Examples of the commercially available products of the compound having an isocyanurate bond include Duranate TPA-100 (manufactured by Asahi Kasei Corporation), Duranate MFA-75B (manufactured by Asahi Kasei Corporation), Duranate TUL-100 (manufactured by Asahi Kasei Corporation), Duranate TSA-100 (manufactured by Asahi Kasei Corporation), Coronate HX (manufactured by Tosoh Corporation) and Takenate D-170N (manufactured by Mitsui Chemicals, Inc.).

Examples of the commercially available products of the compound having a burette bond include Duranate 24A-100 (manufactured by Asahi Kasei Corporation), Duranate 21S-75E (manufactured by Asahi Kasei Corporation), Takenate D-165NN (manufactured by Mitsui Chemicals, Inc.) and Desmodur N3200 (manufactured by Sumika Covestro Urethane Co., Ltd.).

Examples of the commercially available products of the compound having a urethane bond include Duranate P301-75E (manufactured by Asahi Kasei Corp.) and Sumidur HT (manufactured by Sumika Covestro Urethane Co., Ltd.), which are adducts of hexamethylene diisocyanate and trimethylolpropane.

Examples of the commercially available products of the compound having an allophanate bond include Desmodur XP2580 (manufactured by Sumika Covestro Urethane Co., Ltd.).

The mass ratio of the component (A) and the isocyanate compound in the adhesive composition of the present disclosure is not particularly limited, and the equivalent ratio (NCO/COOH) of isocyanate groups in the isocyanate compound to carboxylic acid groups in the component (A) is preferably from 0.01 to 12.0. From the viewpoint that excellent initial adhesiveness can be provided, the equivalent ratio is preferably 0.01 or more, more preferably 0.04 or more, even more preferably 0.1 or more, and particularly preferably 1.0 or more. In addition, from the viewpoint that excellent adhesiveness with a metal can be provided, the equivalent ratio is preferably 12.0 or less, more preferably 9.0 or less, and even more preferably 6.0 or less.

As for the NCO content ratio of the component (B) and the component (C) in the adhesive composition of the present disclosure, in a case in which the total content of the component (B) and the component (C) is 100%, the ratio of the component (B) is preferably from 10 to 100% and the ratio of the component (C) is preferably from 0 to 90%. From the viewpoint that the effect of increasing the cross-linking density of the cured product is high, and the high-temperature peel strength can be improved, the ratio of the component (B) is preferably from 20 to 90%, more preferably from 30 to 90%, and even more preferably from 50 to 90%. Further, from the viewpoint that the adhesion to the adherend can be improved, the ratio of the component (C) is preferably from 10 to 80%, more preferably from 10 to 70%, and even more preferably from 10 to 50%.

3. Organic Solvent

In the adhesive composition of the present disclosure, an organic solvent is included for the purpose of dissolving the component (A).

Specific examples of the organic solvent include aromatic organic solvents such as toluene and xylene; aliphatic organic solvents such as n-hexane; alicyclic organic solvents such as cyclohexane, methylcyclohexane and ethylcyclohexane; ketone-based organic solvents such as acetone and methyl ethyl ketone; alcohol-based organic solvents such as methanol and ethanol; ester-based organic solvents such as ethyl acetate and butyl acetate; and propylene glycol ether-based organic solvents such as propylene glycol methyl ether, propylene glycol ethyl ether and propylene glycol-t-butyl ether.

In the adhesive composition of the present disclosure, one organic solvent may be used alone, or two or more organic solvents may be used in combination.

As the organic solvent, organic solvents which can be easily volatilized and removed by, for example, heating the adhesive composition, are preferable, and it is more preferable to use a mixed solvent of an alicyclic organic solvent and an ester-based or ketone-based organic solvent.

In the adhesive composition of the present disclosure, the mass ratio of the organic solvent and the component (A) is not particularly limited, and the mass ratio can be set according to type or the like of the organic solvent and the modified polyolefin resin.

The content of the component (A) is preferably from 5 to 25% by mass, and more preferably from 10 to 20% by mass, in a case in which the total amount of the organic solvent and the component (A) is 100% by mass. In the case of such a content, the adhesive composition is easily applied to the adherend and is excellent in workability.

4. Other Components

Although the adhesive composition of the present disclosure contains the organic solvent and the components (A) to (C), various components can be included depending on the purpose.

Specific examples of the other components include a curing catalyst, a styrenic thermoplastic elastomer, a tackifier, an antioxidant, a hindered amine-based light stabilizer, an ultraviolet absorber, an antistatic agent, a flame retardant, a colorant, a dispersant, an adhesion-imparting agent, an antifoaming agent, a leveling agent, a plasticizer, a lubricant and a filler.

These components will be described below.

As for the other components described below, one of the exemplified compounds may be used alone, or two or more thereof may be used in combination.

4-1. Curing Catalyst

A curing catalyst can be included in the adhesive composition of the present disclosure for the purpose of promoting a cross-linking reaction between the component (A) and the isocyanate compound, and obtaining excellent adhesion performance.

It is preferable that the adhesive composition of the present disclosure further contains a curing catalyst from the viewpoint of ease of curing and adhesion performance, and the curing catalyst is preferably an organotin compound, a tertiary amine or the like.

Specific examples of the organotin compound include dioctyltin fatty acids having an alkyl group with 3 to 10 carbon atoms, such as dibutyltin dilaurate, dibutyltin dimaleate, dioctyltin dilaurate and dioctyltin dimaleate.

Specific examples of the tertiary amine include tetraalkylethylene diamine such as tetramethylethylene diamine; N,N′-dialkylbenzylamine such as dimethylbenzylamine; and triethylenediamine, pentamethyldiethylenetriamine, N-ethylmorphylin, N-methylmorphylin, 1-methyl-4-dimethylamine ethylpiperazine and 1,8-diazabicyclo[5.4.0]undec-7-ene.

As the curing catalyst, an organotin compound and a tertiary amine can also be used in combination.

The content ratio of the curing catalyst is preferably from 0.001 to 5 parts by mass with respect to 100 parts by mass of the total amount of the components (A) to (C). Due to the ratio of the curing catalyst being set to 0.001 parts by mass or more, a sufficient catalytic effect is easily obtained, and due to the ratio of the curing catalyst being set to 5 parts by mass or less, storage stability of the adhesive composition and a usable life after blending the curing agent can be ensured.

4-2. Styrenic Thermoplastic Elastomer

A styrenic thermoplastic elastomer can be included in the adhesive composition of the present disclosure for the purpose of improving adhesive strength.

Specific examples of the styrenic thermoplastic elastomer include styrenic resins such as a styrene-butadiene copolymer, an epoxy-modified styrene-butadiene copolymer, a styrene-butadiene-styrene block copolymer, a styrene-ethylene/propylene-styrene block copolymer (hereinafter referred to as “SEPS”), a styrene-ethylene/butylene-styrene block copolymer (hereinafter referred to as “SEBS”), a styrene-isoprene/butadiene-styrene block copolymer, and a styrene-isoprene-styrene block copolymer, and these may not have an acidic group or an acid anhydride group, or may have an acidic group and/or an acid anhydride group, or may have an amino group.

As a modification method for introducing the acidic group and/or the acid anhydride group, a known method can be employed. An example includes graft modification such as melt-kneading the above-mentioned acidic group-containing monomer and/or the above-mentioned acid anhydride group-containing monomer with the above-mentioned styrenic resin in the presence of a radical polymerization initiator such as an organic peroxide or an aliphatic azo compound.

As a modification method for introducing an amino group, a known method can be employed. Examples include a terminal modification such as adding an amino group-containing compound to a living terminal of the above-mentioned styrenic resin obtained by living anionic polymerization, and graft modification such as melt-kneading an amine compound having an unsaturated bond such as 2-(1-cyclohexenyl)ethylamine with the above-mentioned styrenic resin in the presence of a radical polymerization initiator such as an organic peroxide or an aliphatic azo compound.

Among styrenic thermoplastic elastomers, SEPS and SEBS are preferable from the viewpoint that adhesive strength can be improved.

4-3. Tackifier

A tackifier can be included in the adhesive composition of the present disclosure for the purpose of improving adhesive strength.

As the tackifier, known tackifiers can be used, and examples thereof include a polyterpene-based resin, a rosin-based resin, an aliphatic petroleum resin, an alicyclic petroleum resin, a copolymer-based petroleum resin and a hydrogenated petroleum resin.

Specific examples of the polyterpene-based resin include an α-pinene polymer, a β-pinene polymer, and a copolymer of these polymers with phenol, bisphenol A or the like.

Specific examples of the rosin-based resin include natural rosin, polymerized rosin, and ester derivatives thereof.

A specific example of the aliphatic petroleum resin is a resin which is also called a C5-based resin and which is generally synthesized from the C5 fraction of petroleum. A specific example of the alicyclic petroleum resin is a resin which is also called a C9-based resin and which is generally synthesized from the C9 fraction of petroleum.

Specific examples of the copolymer-based petroleum resin include a C5/C9 copolymer-based resin and the like.

The hydrogenated petroleum resin is a resin which is generally produced by hydrogenation of the respective petroleum resins described above.

The content of the tackifier is preferably from 1 to 20% by mass, and more preferably from 1 to 10% by mass, with respect to 100% by mass of the adhesive composition, from the viewpoint that hot water resistance is excellent.

5. Adhesive Composition

The adhesive composition of the present disclosure contains the organic solvent and the components (A) to (C), and, preferably, a curing catalyst.

The viscosity at 25° C. of the adhesive composition of the present disclosure is preferably from 10 to 5,000 mPa·s. From the viewpoint of coatability being excellent, 10 mPa·s or higher is preferable. Further, from the viewpoint of leveling properties being excellent, 5,000 mPa·s or less is preferable, and 1,000 mPa·s or less is more preferable.

The adhesive composition of the present disclosure is suitable for adhesion between a polyolefin resin molded body and another member (a metal member, a resin member, and the like), and can be used for not only adhesion of polyolefin resin molded bodies, such as polyolefin resin films, with each other, but also adhesion between a polyolefin resin film and a metal foil made from aluminum or the like, adhesion between a polyolefin resin film and a metal layer of a composite film having a resin layer and the metal layer, and the like. The adhesive layer has high room-temperature peel strength and high high-temperature peel strength and is excellent in adhesiveness, and also has high electrolyte resistance. Therefore, the adhesive layer can be preferably used as a packaging material for lithium ion batteries.

6. Production Method of Adhesive Composition

A second aspect of the present invention (a production method of the adhesive composition of the present disclosure) can be produced by a known method.

Specific methods include a method in which a solution of the component (A) dissolved in an organic solvent is mixed with the other components excluding the isocyanate compound, and then the obtained mixture is mixed with the isocyanate compound. The temperature at the time of mixing is preferably 40° C. or lower, and more preferably from 10° C. to 30° C.

7. Thermally Fusible Member

A third aspect of the present invention (a thermally fusible member of the present disclosure) is a thermally fusible member including an adhesive layer formed by curing the adhesive composition according to the first aspect of the present invention, a metal layer bonded to one side of the adhesive layer, and a thermally fusible resin layer bonded to another side of the adhesive layer.

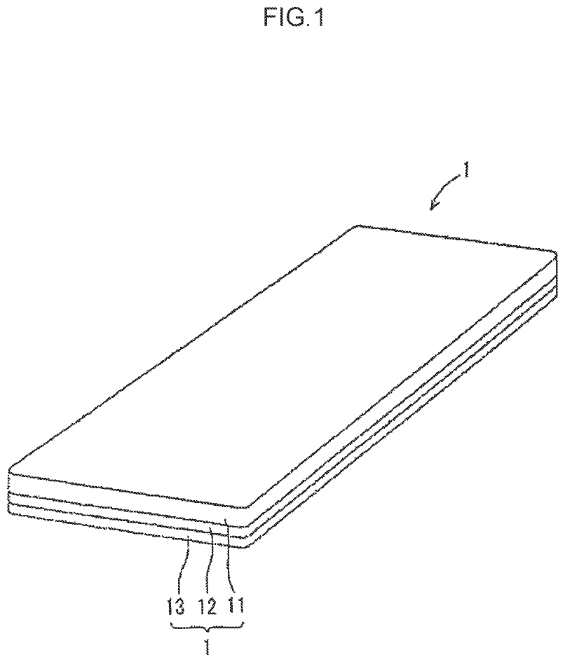

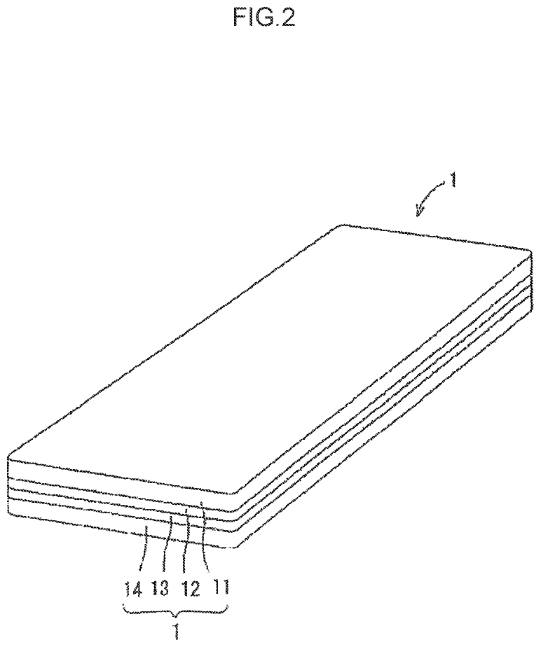

Schematic views of the thermally fusible member of the present disclosure are shown in FIG. 1 and FIG. 2. That is, a thermally fusible member 1 in FIG. 1 includes a thermally fusible resin layer 11, an adhesive layer 12, and a metal layer 13 in this order. Further, a thermally fusible member 1 in FIG. 2 includes a thermally fusible resin layer 11, an adhesive layer 12, a metal layer 13, and another layer 14 in this order.

The shape of the thermally fusible member of the present disclosure may be appropriately set according to the intended use and the like, and although not being particularly limited, examples thereof include a film shape, a sheet shape, a plate shape, an angled shape and a rod shape.

The above-mentioned thermally fusible resin layer is a layer including a resin that melts by heat, and this resin can fusion-bond a material constituting a layer on one side and a material constituting a layer on the other side. The thermally fusible resin layer is preferably a layer including a resin that melts at a temperature of from 50° C. to 200° C. Examples of resins having such properties include a polyolefin resin, a polyamide resin and a polyester resin. Among these, a polyolefin resin is preferable since it can thermally fusion-bond them with sufficient strength, and polypropylene is more preferable as the polyolefin resin. In particular, unstretched polypropylene is more preferable because of little dimensional change (shrinkage) in a case in which the thermally fusible member is used to integrate another member therewith.

The above-mentioned thermally fusible resin layer may be a layer containing an additive such as a lubricant, a filler, a heat stabilizer, an antioxidant, an ultraviolet absorber, an antistatic agent, a flame retardant, a colorant, a dispersant and an adhesion-imparting agent, as necessary.

The thickness of the above-mentioned thermally fusible resin layer changes depending on the material of the resin and the like, and although not being particularly limited, for example, in the case of the layer containing an unstretched polypropylene, is preferably from 10 to 200 μm, and more preferably from 20 to 100 μm. If the thickness of the layer containing the unstretched polypropylene is from 10 to 200 μm, a thermally fusion-bonded composite product, such as a highly durable sealed container which is not easily damaged, can be obtained.

The above-mentioned adhesive layer is a layer formed by curing the adhesive composition of the present disclosure. Although the thickness of the adhesive layer is not particularly limited, it is preferably from 1 to 20 μm, and more preferably from 2 to 10 μm. If the thickness of the adhesive layer is from 1 to 20 μm, processing such as bending is easy in the case in which the thermally fusible member is, for example, in a sheet shape.

The above-mentioned metal layer is a layer containing a metal or an alloy. Examples of the metal or alloy include aluminum, iron, titanium, magnesium, copper, nickel, chromium and other metals, and alloys thereof. Among these, aluminum is preferable since it has excellent workability. The thickness of the metal layer changes depending on the material and the like, and is not particularly limited. In the case that the metal layer is made from, for example, aluminum, the thickness is preferably from 20 to 100 μm, more preferably from 20 to 80 μm, and even more preferably from 30 to 60 μm.

In the case that the thermally fusible member of the present disclosure includes a metal layer, another layer 14 can be provided on the surface of the metal layer 13 as shown in FIG. 2. The material constituting the other layer preferably includes a resin, from the viewpoint of protecting the metal layer. That is, the other layer is preferably a resin layer. This resin is not particularly limited, and can be a polyamide resin, a polyester resin or the like. Although the transparency of the resin layer is not particularly limited, when this resin layer is transparent or translucent, an excellent appearance can be obtained in a case in which the thermally fusible member is made into a sealed container or the like as a thermally fusion-bonded composite product. Although the thickness of the other layer is not particularly limited, it is preferably from 30 to 60 μm, and more preferably from 30 to 50 μm.

The thermally fusible member using the adhesive composition of the present disclosure has high room-temperature peel strength and high high-temperature peel strength, is excellent in adhesiveness and, due to having excellent resistance to a solvent such as an electrolyte, can prevent deterioration of contents while maintaining structure.

In the case of use as a packaging material for lithium ion batteries, the adhesiveness and the like can be maintained in temperature change in battery storage or in a usage environment, in particular, in a chemical temperature rise of materials constituting the battery associated with charging or discharging, in summer, or in a temperature range higher than room temperature in automobiles or the like.

8. Production Method of Thermally Fusible Member

A fourth aspect of the present invention (a method of producing a thermally fusible member of the present disclosure) is a method of producing the thermally fusible member according to the third aspect of the present invention.

For example, production methods of the thermally fusible member shown in FIG. 1 include the following (1) and (2).

(1) A method including applying the adhesive composition to a surface of a metal foil, a metal film or the like for forming the metal layer 13, then removing the organic solvent contained in the composition to form the adhesive layer 12, and subsequently bringing the surface of the thus-formed adhesive layer 12 into contact with a resin film for forming the thermally fusible resin layer 11 (hereinafter referred to as “thermally fusible resin film”) and pressure bonding them while heating.

(2) A method including applying the adhesive composition to the surface of the thermally fusible resin film, then removing the organic solvent contained in the composition to form the adhesive layer 12, and subsequently bringing the surface of the thus-formed adhesive layer 12 into contact with a metal foil or the like for forming the metal layer 13 and pressure bonding them while heating.

Further, for example, production methods of the thermally fusible member shown in FIG. 2 include the following (3) to (5).

(3) A method including applying the adhesive composition to the surface of the metal layer 13 of a composite film that includes a resin layer constituting the other layer 14 and the metal layer 13 formed on one side of the resin layer by vapor deposition or the like, then removing the organic solvent contained in the composition to form the adhesive layer 12, and subsequently bringing the surface of the thus-formed adhesive layer 12 into contact with the thermally fusible resin film and pressure bonding them while heating.

(4) A method including applying the adhesive composition to the surface of the thermally fusible resin film, then removing the organic solvent contained in the composition to form the adhesive layer 12, and subsequently bringing the surface of the thus-formed adhesive layer 12 into contact with the surface of the metal layer 13 of a composite film that includes a resin layer constituting the other layer 14 and the metal layer 13 formed on one side of the resin layer by vapor deposition or the like and pressure bonding them while heating.

(5) A method of extrusion molding a film for forming the other layer 14 on the surface of the metal layer 13 of the layered body obtained by method (1) or (2) above.

The adhesive composition is often applied to a material for forming a metal layer such as a metal foil, or a surface of a metal layer of a composite film that includes a metal layer and another layer (resin layer), but is not particularly limited to this. In a case in which a metal foil is used, it is preferable to use an aluminum foil having a thickness of from 20 to 100 μm. As a result, it is possible to easily form a thermally fusible member in which damage is suppressed. Further, in a case in which a composite film is used, it is preferable that a metal layer contains aluminum and the other layer (resin layer) contains a polyamide resin, a polyester resin or the like. In addition, in a case in which the thermally fusible member shown in FIG. 2 is produced without using a composite film, that is, in a case in which the above method (5) is employed, it is preferable to use a film including a polyamide resin, a polyester resin or the like as a film for forming the other layer 14.

As the thermally fusible resin film, a polyolefin resin film, a polyamide resin film, a polyester resin film and the like can be used. These resin films can be films obtained by film forming methods such as an extrusion method, a cast molding method, a T-die method, and an inflation method. The thickness of the thermally fusible resin film is preferably from 10 to 200 μm. In the present disclosure, a polyolefin resin film is preferable from the viewpoint that thermal fusion for completing the thermally fusible member and thermal fusion at the time of manufacturing a thermally fusion-bonded composite product can be easily performed, and an unstretched polypropylene film is more preferable from the viewpoint that a thermally fusion-bonded composite product such as a sealed container that is difficult to damage and has excellent durability can be obtained. In the case of using this unstretched polypropylene film, a preferable thickness is from 10 to 200 μm, and more preferably from 20 to 100 μm.

The adhesive composition can be applied by a conventionally known method, and can be applied by using, for example, a bar coater, a gravure coater or the like. The thickness of the coating film and the drying temperature thereof are not particularly limited. The drying temperature of the coating film is not particularly limited, and is preferably from 30° C. to 100° C. from the viewpoint of workability.

As described above, the dried coating film generally has tackiness and adhesiveness and thus can bond two members without heating. However, in the case of producing the thermally fusible member of the present disclosure, for example, a method using pressure bonding or the like while heating to a temperature taking into account the melting point, melt viscosity and the like of the resin component based on the modified polyolefin resin can be applied. As for heating conditions and pressure bonding conditions, for example, the temperature is 180° C., the pressure is 0.3 MPa, and a time period of the pressure bonding is 2 seconds.

In addition, conditions for promoting a cross-linking reaction between the component (A) and the isocyanate compound to complete the thermally fusible member (hereinafter referred to as “aging conditions”) are not particularly limited, and it is preferable to set the conditions according to the material of the metal foil, the material of the thermally fusible resin film, the melting temperature and the like, and the composition and the like of the adhesive layer. As for aging conditions, heating may be performed at 40° C. for about 3 to 7 days, and a polyolefin having an acidic group and/or an acid anhydride group and an ethylenically unsaturated group may be used as the component (A) to perform curing by active energy rays such as ultraviolet rays and electron beams in combination with heating, in order to shorten the aging time.

9. Application

The thermally fusible member of the present disclosure can be used in various fields of industrial products such as electrical fields, automotive fields, and industrial fields and other fields.

Examples of applications in electrical fields include packaging materials for secondary batteries such as lithium ion batteries and lithium ion polymer batteries, decoration by attaching decorative sheets in mobile devices, housings of television sets, housings of household electrical appliances and the like, bonding between a metal member and a resin, sealing of electronic components and the like.

Examples of applications in automotive fields include adhesion of an exterior material formed of a metal member/resin in interior/exterior members such as a pillar, a mall, a door trim, a spoiler and a roof, and adhesion of a base material with genuine leather, fabrics, an instrument panel foamed sheet, and a decorative sheet.

Examples of applications in industrial fields include adhesion between films of an industrial packaging material and a multilayer film such as a barrier film.

Examples of applications in other fields include bonding of logistics materials, housing and building materials, everyday goods, and sporting goods.

Among these, packaging materials for lithium ion batteries are preferable as the application of the thermally fusible member of the present disclosure since the thermally fusible member has high room-temperature peel strength and high high-temperature peel strength and are excellent in adhesiveness, and also have high electrolyte resistance.

### EXAMPLES

Hereinafter, the present invention will be described in more detail with reference to Examples and Comparative Examples, but the present invention is not limited to the Examples shown below.

### 1. Production Example

### 1) Production Example 1 [Production of Component (A)]

100 parts by mass of a propylene-1-butene copolymer (79 mol % of propylene component, 21 mol % of 1-butene component, weight average molecular weight of 180,000, and Tm=85° C.), 2.8 parts by mass of maleic anhydride, 2 parts by mass of lauryl methacrylate, and 0.8 parts by mass of 2,5-dimethyl-2,5-di(t-butylperoxy)hexane were poured into a twin screw extruder (L/D=42 and 4)=58 mm). The reaction was carried out at a residence time of 10 minutes and a barrel temperature of 180° C. (in 1st to 7th barrels), and degassing was performed in the 7th barrel to remove the remaining unreacted maleic anhydride and lauryl methacrylate to obtain a reaction product (hereinafter referred to as “component A1”).

### 2) Production Example 2 [Production of Component (A)]

In a four-neck flask equipped with a stirrer, a condenser, and a dripping funnel, 100 parts by mass of a propylene-ethylene copolymer (97 mol % of propylene component and 3 mol % of ethylene component, weight average molecular weight of 250,000, and Tm=125° C.) was heated and dissolved in 400 parts by mass of toluene, then 1 part by mass of dicumyl peroxide was added dropwise while maintaining the temperature in the system at 110° C. and stirring, and then a degradation treatment was performed for 1 hour. Next, 1.5 parts by mass of aconitic anhydride, 3 parts by mass of octyl acrylate, and 0.5 parts by mass of benzoyl peroxide were each added dropwise to the mixture over 3 hours, and the resultant mixture was allowed to react further for 1 hour. After the reaction, the reaction product was cooled to room temperature, and then the crude reaction product was poured into a large excess of acetone, and unreacted aconitic anhydride and octyl acrylate were removed to obtain a reaction product (hereinafter referred to as “component A2”).

### 3) Production Example 3 [Production of Component (A)]

100 parts by mass of a propylene-ethylene-1-butene copolymer (68 mol % of propylene component, 8 mol % of ethylene component, and 24 mol % of 1-butene component, weight average molecular weight of 50,000, and Tm=70° C.), 8 parts by mass of itaconic anhydride, 5 parts by mass of tridecyl acrylate, and 2 parts by mass of lauroyl peroxide were poured into a twin screw extruder similar to that in Production Example 1. The reaction was carried out at a residence time of 10 minutes and a barrel temperature of 170° C. (in 1st to 7th barrels), and degassing was performed in the 7th barrel to remove the remaining unreacted itaconic anhydride and tridecyl acrylate to obtain a reaction product (hereinafter referred to as “component A3”).

### 4) Production Example 4 [Production of Component (B)]

In a 500 mL four-neck flask equipped with a stirrer, a thermometer, a nitrogen gas introduction tube, and a Dimroth condenser, 570 g of hydrogenated diphenylmethane diisocyanate (hereinafter abbreviated as hydrogenated MDI) and 17 g of isobutanol were prepared, heated to 85° C., and kept for 3 hours, and then 0.12 g of trimethyl-N-2-hydroxypropylammonium 2-ethylhexanoate was added as a catalyst. After continuing the reaction for 3 hours while adjusting the reaction temperature to 85±5° C., 0.1 g of benzoyl chloride was added to deactivate the catalyst and the reaction was terminated. The obtained reaction solution was treated in a thin film distillation apparatus (vacuum degree 0.5 mmHg, temperature 180° C.) to remove unreacted hydrogenated MDI, and 150 g (conversion rate 25%) of pale yellow transparent polyisocyanate having no fluidity at room temperature was obtained. A solution (hereinafter referred to as “component B 1”) obtained by diluting this polyisocyanate with ethyl acetate to a solid content of 75%, had an isocyanate group content of 10%.

### 2. Method of Evaluating Reaction Product

The weight-average molecular weight, the melting point, the graft amount of the acidic group-containing monomer and/or acid anhydride group-containing monomer, and the graft amount of the (meth)acrylic acid long chain alkyl ester of the reaction products A1 to A3 obtained in Production Examples 1 to 3 were measured according to the methods described later.

The results are shown in Table 1.

(1) Weight-Average Molecular Weight

Apparatus: HLC-8220GPC (manufactured by Tosoh Corporation)

Column: 2 TSKgel GMHXLs (manufactured by Tosoh Corporation)

Column temperature: 40° C.

Eluent: tetrahydrofuran 1.00 ml/min

Detector: RI (differential refractometer)

The molecular weight measured by GPC was converted based on the molecular weight of polystyrene.

(2) Melting Point

In accordance with the provisions of JIS K 7121 (established in 1987), measurement was performed at a temperature increase rate of 10° C./min using a differential scanning calorimeter, and the temperature at the time of crystallization was taken as the melting point.

(3) Graft Amount of Acid Anhydride Group-Containing Monomer

The graft amount of the acid anhydride group-containing monomer is defined by the following formula from the acid value obtained by the measurement described later.

Graft amount (% by mass)=acid value×(M+1.008)×100/(1000×56.1×V)

M=molecular weight of acid anhydride group-containing monomer

V=valence of acidic groups when the acid anhydride group-containing monomer is hydrolyzed

The graft amounts of the acid anhydride group-containing monomers of the reaction products A1 to A3 were calculated according to the following formulae.

Graft amount of A1 (% by mass)=acid value×99.1×100/(1000×56.1×2)

Graft amount of A2 (% by mass)=acid value×157.1×100/(1000×56.1×3)

Graft amount of A3 (% by mass)=acid value×113.1×100/(1000×56.1×2)

Method for Measuring Acid Value

The acid value indicates the number of milligrams of potassium hydroxide required to neutralize the acid contained in 1 g of the sample, and was measured in accordance with JIS K 0070:1992.

Specifically, a sample solution is obtained by accurately weighing 0.2 g of a sample to be measured in an Erlenmeyer flask with a stopper, adding 20 ml of tetrahydrofuran, and dissolving while heating. Subsequently, several drops of a 1 w/v % phenolphthalein ethanol solution were added, as an indicator, to this sample solution, titration was carried out using an ethanol solution of 0.1 mol/L potassium hydroxide ethanol solution as a titrant until a rose-pink color lasting for 10 seconds was exhibited, and the acid value was calculated according to the following formula.

Acid value (mgKOH/g)=(T×F×56.11×0.1)/W

Here, in the above calculation formula, T represents the titration amount (mL), F represents a factor of the titrant, and W represents an amount (g) of the sampling amount.

(4) Graft Amount of (Meth)Acrylic Acid Long Chain Alkyl Ester

First, the (meth)acrylic acid long chain alkyl esters (concentration (% by mass): C₁, C₂ and C₃), which are raw materials of the above-mentioned reaction products A1 to A3, were mixed with the polyolefins, which are raw materials of the above-mentioned reaction products A1 to A3, using a twin-screw extruder similar to that in Production Example 1, and three types of films (thickness: 100 μm) were obtained, using a hot press, in which the concentrations of the (meth)acrylic acid long chain alkyl esters were different.

Infrared absorption spectra of the above-mentioned three types of films were measured by Fourier transform infrared spectroscopy, and absorbance ratios Y₁, Y₂ and Y₃ were determined according to the following formulae, and calibration curves for the concentrations C₁, C₂ and C₃ were created.

Absorbance ratio Y=(absorbance originating in stretching vibration of ester carbonyl (1730±10 cm⁻¹))/(absorbance originating in stretching vibration of ester carbonyl (1730±10 cm⁻¹))

Y₁: Y at a concentration of C₁

Y₂: Y at a concentration of C₂

Y₃: Y at a concentration of C₃

Next, the infrared spectra of the above-mentioned reaction products A1 to A3 were measured, and the absorbance ratios Y_{A1} (Y of the reaction product A1), Y_{A2} (Y of the reaction product A2) and Y_{A3} (Y of the reaction product A3) were determined, and graft amounts of the (meth)acrylic acid long chain alkyl esters were calculated according to the following formulae based on the above calibration curves.

Graft amount of A1 (% by mass)=(Y_{A1}−b)/a

Graft amount of A2 (% by mass)=(Y_{A2}−b)/a

Graft amount of A3 (% by mass)=(Y_{A3}−b)/a

a=(3f−d×e)/(3c−d²)

b=(c×e−f×d)/(3c−d²)

c=C₁²+C₂²+C₃²

d=C₁+C₂+C₃

e=Y₁+Y₂+Y₃

f=C₁Y₁+C₂Y₂+C₃Y₃

TABLE 1

| | | | | Graft Amount | |
|---|---|---|---|---|---|
| | | | | of Acid | Graft Amount |
| | | | | Anhydride | of (Meth) |
| | | Weight- | | Group- | Acrylic Acid |
| | | Average | Melting | Containing | Long Chain |
| | | Molecular | Point | Monomer | Alkyl Ester |
| | | Weight | (° C.) | (% by weight) | (% by weight) |
| Production | A1 | 150,000 | 85 | 2.4 | 1.6 |
| Example 1 | | | | | |
| Production | A2 | 82,000 | 80 | 1.2 | 2.8 |
| Example 2 | | | | | |
| Production | A3 | 36,000 | 60 | 7.5 | 4.6 |
| Example 3 | | | | | |

### 3. Examples 1 to 21 and Comparative Examples 1 to 3

### 1) Preparation of Adhesive Compositions

A component (A) and each of the organic solvents shown in the following Table 2 were prepared in a flask having an internal volume of 300 mL and equipped with a condenser and a stirrer, and stirred at 60° C. for 30 minutes to obtain a solution. After the solution was cooled to room temperature, a curing catalyst was added to the solution and further mixed to obtain a liquid resin composition.

Next, a component (B) and a component (C), which are isocyanate compounds shown in Table 2, were blended and mixed with the resin composition at the ratio shown in Table 2 to obtain the adhesive composition.

In preparing the test pieces described later, the adhesive composition was used within 1 hour after the isocyanate compounds were blended.

The evaluations described below were carried out using the obtained adhesive compositions shown in Table 2. The results are shown in Table 2.

The numbers in Table 2 mean parts by mass.

Further, the abbreviations in Table 2 mean the following.

[Curing Catalyst]

DBU: 1,8-diazabicyclo[5.4.0]undec-7-ene, manufactured by San-Apro Ltd.

DBTL: dibutyltin dilaurate, manufactured by ADEKA Corporation

[Component (B)]

Takenate D-127N: isocyanurate of 1,3-bis(isocyanatomethyl)cyclohexane, manufactured by Mitsui Chemicals, Inc., trade name

Takenate 600: 1,3-diisocyanate methylcyclohexane, manufactured by Mitsui Chemicals, Inc., trade name

Fortimo: 1,4-bis(isocyanatomethyl)cyclohexane, manufactured by Mitsui Chemicals, Inc., trade name

HMDI: a mixture of 4,4′-methylenebis(cyclohexyl isocyanate) and isomers, manufactured by Wanhua Chemical Group Co., Ltd.

Cosmonate NBDI: Norbornan dimethyl isocyanate, manufactured by Mitsui Chemicals, Inc., trade name

Desmodur Z4470: isocyanurate of isophorone diisocyanate, manufactured by Sumika Covestro Urethane Co., Ltd., trade name “Desmodur Z4470BA”

IPDI: isophorone diisocyanate (isomer mixture)

[Component (C)]

TPA100: isocyanurate of hexamethylene diisocyanate, manufactured by Asahi Kasei Corporation, trade name “Duranate TPA-100”

N3200: burette of hexamethylene diisocyanate, manufactured by Sumika Covestro Urethane Co., Ltd., trade name “Desmodur N3200”

HT: adduct of hexamethylene diisocyanate and trimethylolpropane, manufactured by Sumika Covestro Urethane Co., Ltd., trade name “Sumidur HT”

XP2580: allophanate of hexamethylene diisocyanate, manufactured by Sumika Covestro Urethane Co., Ltd., trade name “Desmodur XP2580”

HDI: hexamethylene diisocyanate

[Others]

Desmodur L75: adduct of tolylene diisocyanate, manufactured by Sumika Covestro Urethane Co., Ltd., trade name “Desmodur L75”

Sumidur 44V20: isomer mixture of diphenylmethane diisocyanate, manufactured by Sumika Covestro Urethane Co., Ltd., trade name “Sumidur 44V20”

2) Production of Test Piece

The adhesive composition was applied to an aluminum foil (size: 100 mm×200 mm, thickness: 40 μm, and surface treatment: chemical conversion treatment) with a bar coater, then dried at 80° C. for 60 seconds, and further dried at 180° C. for 20 seconds to remove the organic solvents contained in the adhesive composition, and thereby an adhesive layer having a film thickness of 4 μm was formed.

Next, an unstretched polypropylene film (thickness 80 μm, hereinafter referred to as “CPP”), as a thermally fusible resin film, was affixed to the surface of the adhesive layer, and pressure was applied from the surface of the aluminum foil to pressure bond them to each other using a thermal inclination tester. The bonding conditions at this time were set to be a temperature of 180° C., a pressure of 0.3 MPa, and a time period of pressure bonding of 2 seconds.

Thereafter, this integrated product was housed in a hot-air circulation oven having a temperature adjusted to 40° C. for 3 days to obtain a test piece.

3) Evaluation of Test Piece

The test piece obtained in 2) above was used for the evaluation described later.

(1) Adhesiveness

[Room-Temperature Peel Strength]

The above-mentioned test piece was cut into a width of 15 mm, and the room-temperature peel strength (at a measurement temperature of 25° C.) between the aluminum foil and the CPP was measured by a T peel test (at a tensile speed of 100 mm/min). The results are shown in Table 2.

[High-Temperature Peel Strength]

The above-mentioned test piece was cut into a width of 15 mm, and the high-temperature peel strength (at a measurement temperature of 80° C. and 120° C.) between the aluminum foil and the CPP was measured by a T peel test (at a tensile speed of 100 mm/min). The results are shown in Table 2.

(2) Electrolyte Resistance

As an electrolytic solution, one was used in which ethylene carbonate, diethyl carbonate, and dimethyl carbonate were mixed at a ratio of 1:1:1 (mass ratio), and lithium hexafluorophosphate was added thereto at a concentration of 1 mol/L.

After the above-mentioned test piece was immersed in the electrolytic solution at 80° C. for 8 days, the room-temperature peel strength (at a measurement temperature of 25° C.) between the aluminum foil and the CPP was measured by a T peel test (at a tensile speed of 100 mm/min). The results are shown in Table 2.

TABLE 2

| | | | Examples | | | | | | | |
|---|---|---|---|---|---|---|---|---|---|---|
| | Component | | 1 | 2 | 3 | 4 | 5 | 6 | 7 | 8 |
| Component | A1 | (g) | 15 | 15 | 15 | 15 | 15 | 15 | 15 | 15 |
| (A) | A2 | (g) | | | | | | | | |
| | A3 | (g) | | | | | | | | |
| | Synthetic Example 4 | (g) | | | | | | | | |
| | Synthetic Example 5 | (g) | | | | | | | | |
| | Synthetic Example 6 | (g) | | | | | | | | |
| Organic | Methylcyclohexane | (g) | 68 | 68 | 68 | 68 | 68 | 68 | 68 | 68 |
| Solvent | Methyl Ethyl Ketone | (g) | 17 | 17 | 17 | 17 | 17 | 17 | 17 | 17 |
| Curing | DBU | (g) | 0.08 | 0.08 | 0.08 | 0.08 | 0.08 | 0.08 | 0.08 | 0.08 |
| Catalyst | DBTL | (mg) | | | | | | | | |
| Component | Takenate D-127N | (g) | 3.3 | | | | | | | |
| (B) | Takenate 600 | (g) | | 1.1 | | | | | | |
| | Fortimo | (g) | | | 1.1 | | | | | |
| | B1 | (g) | | | | 4.7 | | | | |
| | HMDI | (g) | | | | | 1.4 | | | |
| | Cosmonate NBDI | (g) | | | | | | 1.1 | | |
| | Desmodur Z4470 | (g) | | | | | | | 4.0 | |
| | XP2565 | (g) | | | | | | | | 2.0 |
| | D-140N | (g) | | | | | | | | |
| | EP-DC1241 | (g) | | | | | | | | |
| | IPDI | (g) | | | | | | | | 1.2 |
| Component | TPA100 | (g) | | | | | | | | |
| (C) | N3200 | (g) | | | | | | | | |
| | HT | (g) | | | | | | | | |
| | XP2580 | (g) | | | | | | | | |
| | HDI | (g) | | | | | | | | |
| Others | Desmodur L75 | (g) | | | | | | | | |
| | Sumidur 44V20 | (g) | | | | | | | | |
| NCO/COOH (equivalent ratio) | | | 1.5 | 1.5 | 1.5 | 1.5 | 1.5 | 1.5 | 1.5 | 1.5 |
| NCO % (B)/((B) + (C)) | | | 100 | 100 | 100 | 100 | 100 | 100 | 100 | 100 |
| Adhesiveness | T Peel Strength | 25° C. | 20 | 20 | 21 | 22 | 21 | 20 | 20 | 21 |
| | (N/15 mm) | 80° C. | 10 | 11 | 11 | 10 | 10 | 9 | 8 | 9 |
| | | 120° C. | 7 | 7 | 7 | 6 | 7 | 6 | 5 | 5 |
| Electrolyte | Peel Strength | after 8 | 11 | 10 | 11 | 11 | 10 | 10 | 10 | 11 |
| Resistance | After Immersion | days | | | | | | | | |
| | | | Examples | | | | | | | |
| | Component | | 9 | 10 | 11 | 12 | 13 | 14 | 15 | 16 |
| Component | A1 | (g) | 15 | 15 | 15 | 15 | 15 | 15 | 15 | 15 |
| (A) | A2 | (g) | | | | | | | | |
| | A3 | (g) | | | | | | | | |
| | Synthetic Example 4 | (g) | | | | | | | | |
| | Synthetic Example 5 | (g) | | | | | | | | |
| | Synthetic Example 6 | (g) | | | | | | | | |
| Organic | Methylcyclohexane | (g) | 68 | 68 | 68 | 68 | 68 | 68 | 68 | 68 |
| Solvent | Methyl Ethyl Ketone | (g) | 17 | 17 | 17 | 17 | 17 | 17 | 17 | 17 |
| Curing | DBU | (g) | 0.08 | 0.08 | 0.08 | 0.08 | 0.08 | 0.08 | 0.08 | 0.08 |
| Catalyst | DBTL | (mg) | | | | | | | | |
| Component | Takenate D-127N | (g) | 1.1 | 15.0 | 2.5 | 3.0 | 1.0 | 0.4 | 2.5 | 2.5 |
| (B) | Takenate 600 | (g) | | | | | | | | |
| | Fortimo | (g) | | | | | | | | |
| | B1 | (g) | | | | | | | | |
| | HMDI | (g) | | | | | | | | |
| | Cosmonate NBDI | (g) | | | | | | | | |
| | Desmodur Z4470 | (g) | | | | | | | | |
| | XP2565 | (g) | | | | | | | | |
| | D-140N | (g) | 2.0 | | | | | | | |
| | EP-DC1241 | (g) | | | | | | | | |
| | IPDI | (g) | | | | | | | | |
| Component | TPA100 | (g) | | | 0.5 | 0.2 | 1.4 | 1.8 | | |
| (C) | N3200 | (g) | | | | | | | 0.5 | |
| | HT | (g) | | | | | | | | 1.0 |
| | XP2580 | (g) | | | | | | | | |
| | HDI | (g) | | | | | | | | |
| Others | Desmodur L75 | (g) | | | | | | | | |
| | Sumidur 44V20 | (g) | | | | | | | | |
| NCO/COOH (equivalent ratio) | | | 0.5 | 6.7 | 1.5 | 1.5 | 1.5 | 1.5 | 1.5 | 1.5 |
| NCO % (B)/((B) + (C)) | | | 100 | 100 | 75 | 90 | 30 | 10 | 75 | 73 |
| Adhesiveness | T Peel Strength | 25° C. | 20 | 18 | 24 | 21 | 23 | 22 | 23 | 24 |
| | (N/15 mm) | 80° C. | 8 | 7 | 12 | 10 | 8 | 7 | 13 | 12 |
| | | 120° C. | 5 | 4 | 7 | 7 | 6 | 4 | 6 | 5 |
| Electrolyte | Peel Strength | after 8 | 10 | 8 | 14 | 11 | 13 | 8 | 14 | 15 |
| Resistance | After Immersion | days | | | | | | | | |
| | | | | | | | | Comparative | | |
| | | | Examples | | | | | Examples | | |
| | Component | | 17 | 18 | 19 | 20 | 21 | 1 | 2 | 3 |
| Component | A1 | (g) | 15 | 15 | | | 15 | 15 | 15 | 15 |
| (A) | A2 | (g) | | | 15 | | | | | |
| | A3 | (g) | | | | 15 | | | | |
| | Synthetic Example 4 | (g) | | | | | | | | |
| | Synthetic Example 5 | (g) | | | | | | | | |
| | Synthetic Example 6 | (g) | | | | | | | | |
| Organic | Methylcyclohexane | (g) | 68 | 68 | 68 | 68 | 68 | 68 | 68 | 68 |
| Solvent | Methyl Ethyl Ketone | (g) | 17 | 17 | 17 | 17 | 17 | 17 | 17 | 17 |
| Curing | DBU | (g) | 0.08 | 0.08 | 0.08 | 0.08 | | 0.08 | 0.08 | 0.08 |
| Catalyst | DBTL | (mg) | | | | | 1.5 | | | |
| Component | Takenate D-127N | (g) | 2.5 | 2.5 | 1.6 | 9.0 | 3.3 | | | |
| (B) | Takenate 600 | (g) | | | | | | | | |
| | Fortimo | (g) | | | | | | | | |
| | B1 | (g) | | | | | | | | |
| | HMDI | (g) | | | | | | | | |
| | Cosmonate NBDI | (g) | | | | | | | | |
| | Desmodur Z4470 | (g) | | | | | | | | |
| | XP2565 | (g) | | | | | | | | |
| | D-140N | (g) | | | | | | | | |
| | EP-DC1241 | (g) | | | | | | | | |
| | IPDI | (g) | | | | | | | | |
| Component | TPA100 | (g) | | | | | | 2.0 | | |
| (C) | N3200 | (g) | | | | | | | | |
| | HT | (g) | | | | | | | | |
| | XP2580 | (g) | 0.6 | | | | | | | |
| | HDI | (g) | | 0.3 | | | | | | |
| Others | Desmodur L75 | (g) | | | | | | | 3.6 | |
| | Sumidur 44V20 | (g) | | | | | | | | 1.5 |
| NCO/COOH (equivalent ratio) | | | 1.5 | 1.5 | 1.5 | 1.5 | 1.5 | 1.5 | 1.5 | 1.5 |
| NCO% (B)/((B) +(C)) | | | 74 | 73 | 100 | 100 | 100 | 0 | 0 | 0 |
| Adhesiveness | T Peel Strength | 25° C. | 22 | 23 | 21 | 19 | 20 | 22 | 12 | 11 |
| | (N/15 mm) | 80° C. | 12 | 11 | 10 | 9 | 10 | 6 | 4 | 5 |
| | | 120° C. | 6 | 6 | 5 | 5 | 7 | 2 | 2 | 2 |
| Electrolyte | Peel Strength | after 8 | 14 | 14 | 9 | 8 | 10 | 8 | 3 | 2 |
| Resistance | After Immersion | days | | | | | | | | |

### 4) Evaluation Results

As is clear from Table 2, the adhesive compositions of Examples 1 to 21 had a room-temperature peel strength of 10 N/15 mm or higher, an 80° C. peel strength of 7 N/15 mm or higher, and a 120° C. peel strength of 4 N/15 mm or higher, and were thus excellent in adhesiveness, and were also excellent in electrolyte resistance.

In contrast, the adhesive compositions of Comparative Examples 1 to 3 did not contain (B) an isocyanate compound having an alicyclic structure, and/or a derivative thereof, and accordingly were low in 80° C. peel strength and 120° C. peel strength, and were also inferior in electrolyte resistance.

### INDUSTRIAL APPLICABILITY

The present invention relates to an adhesive composition, a thermally fusible member and a packaging material for a lithium ion battery which use the adhesive composition, and can be used in various fields of industrial products such as electrical fields, automotive fields, and industrial fields, and belongs to these technical fields.

1. An adhesive composition, comprising:
an organic solvent;
(A) a polyolefin that has at least one of an acidic group or an acid anhydride group and that is soluble in the organic solvent; and
an isocyanate compound,
wherein the isocyanate compound is (B) at least one of an isocyanate compound having an alicyclic structure, or a derivative thereof.

2. The adhesive composition according to claim 1, wherein the isocyanate compound having an alicyclic structure is at least one selected from the group consisting of hydrogenated xylylene diisocyanate, a derivative of hydrogenated xylylene diisocyanate, 4,4′-methylenebis(cyclohexyl isocyanate), an isomer of 4,4′-methylenebis(cyclohexyl isocyanate), a derivative of 4,4′-methylenebis(cyclohexyl isocyanate), and a derivative of an isomer of 4,4′-methylenebis(cyclohexyl isocyanate).

3. The adhesive composition according to claim 1, further comprising (C) at least one of an aliphatic isocyanate compound not having an alicyclic structure, or a derivative thereof.

4. The adhesive composition according to claim 3, wherein the aliphatic isocyanate compound not having an alicyclic structure is a compound having a linear alkyl group with 4 to 18 carbon atoms.

5. The adhesive composition according to claim 3, wherein at least one of the derivative of the isocyanate compound having an alicyclic structure or the derivative of the aliphatic isocyanate compound not having an alicyclic structure is a compound including at least one bond selected from the group consisting of an isocyanurate bond, a burette bond, a urethane bond, and an allophanate bond.

6. The adhesive composition according to claim 1, wherein the component (A) is a polyolefin that is graft-modified with at least one of an acidic group-containing monomer or an acid anhydride group-containing monomer, and a graft amount thereof is from 0.10 to 30% by mass.

7. The adhesive composition according to claim 1, wherein the component (A) is a polyolefin that is graft-modified with an esterified product of an alkyl alcohol having 8 to 18 carbon atoms and (meth)acrylic acid, and a graft amount thereof is from 0.10 to 20% by mass.

8. The adhesive composition according to claim 1, wherein a weight-average molecular weight of the component (A) is from 15,000 to 200,000, and a melting point of the component (A) is from 50 to 100° C.

9. A thermally fusible member, comprising:
an adhesive layer that is formed by curing the adhesive composition according to claim 1;
a metal layer that is bonded to one side of the adhesive layer; and
a thermally fusible resin layer that is bonded to another side of the adhesive layer.

10. A packaging material for a lithium-ion battery, comprising the thermally fusible member according to claim 9.
